(19) United States
(12) Patent Application Publication
(10) Pub. No.: US 2023/0276973 A1
(43) Pub. Date: Sep. 7, 2023

(54) PREPARATION VESSEL FOR A KITCHEN APPLIANCE BASE AND KITCHEN APPLIANCE

(71) Applicant: Vorwerk & Co. Interholding GmbH, Wuppertal (DE)

(72) Inventors: Philipp Charopoulos, Ratingen (DE); Sebastian Jansen, Bochum (DE)

(21) Appl. No.: 18/110,413

(22) Filed: Feb. 16, 2023

(30) Foreign Application Priority Data
Feb. 24, 2022 (EP) 22158604.3

(51) Int. Cl. A47J 27/092; A47J 27/08

(52) U.S. Cl. CPC A47J 27/092; A47J 27/0806

(57) ABSTRACT

A preparation vessel arranged on a kitchen appliance base of a kitchen appliance, having at least one preparation space, at least one lid for closing the preparation space, at least one actuator element, and at least one actuating means, wherein the actuator element is movably mounted in an interface area relative to the kitchen appliance base, the actuating means being actuated by the actuator element, and the lid configured to lock or unlock by actuating the actuating means. A kitchen appliance having a preparation vessel is also provided. The preparation vessel and a kitchen appliance, which functions for the preparation of food with an enhanced ease of operation and high user safety, are realized in that at least one valve and at least one valve actuating are provided, and that the valve actuating means can at least be indirectly actuated with the actuating means.

### CROSS REFERENCE TO RELATED APPLICATIONS

This application claims the benefit of priority under 35 U.S.C. § 119 to European Patent Application No.: 22158604.3, filed Feb. 24, 2022, the contents of which is incorporated herein by reference in its entirety.

### FIELD

The invention relates to a preparation vessel to be arranged on a kitchen appliance base of a kitchen appliance.

### BACKGROUND

The statements in this section merely provide background information related to the present disclosure and several definitions for terms used in the present disclosure and may not constitute prior art.

Preparation vessels to be arranged on a kitchen appliance base of a kitchen appliance, as well as corresponding kitchen appliances, are known from conventional art in a variety of embodiments. Such kitchen appliances with a preparation vessel are used for preparing food automatically, semi-automatically or manually, for example, for chopping, grinding, pressing, stirring, cooking, and/or keeping food warm. The receiving area of the kitchen appliance base in particular has at least one electrical interface for supplying a preparation vessel inserted in the receiving area with at least one working voltage, for example, for a heating device or for contacting sensors.

EP 3 875 007 A1 and EP 3 875 003 A1 discloses a preparation vessel, for example, in which the lid can be automatically locked to the preparation vessel by means of a locking device. An additional mechanism which transmits a movement to the lid or a component provided for locking and causes the lid to be locked is provided for this purpose on the locking device that locks the preparation vessel to the kitchen appliance base.

Although the kitchen appliances with automatic locking of the lid known from conventional products already ensure high user safety and a favorable ease of operation, there is still a need to further increase the range of functions of a preparation vessel for the preparation of food.

It is therefore an objective of the present disclosure to disclose a preparation vessel and a kitchen appliance with which the range of functions for the preparation of foods is enhanced with a favorable ease of operation and high user safety.

### SUMMARY

The aforementioned objective of the present disclosure is attained with a generic preparation vessel arranged on a kitchen appliance base of a kitchen appliance. The preparation vessel has at least one preparation space for receiving food and at least one lid for closing the preparation vessel. Furthermore, the preparation vessel has at least one actuator element and at least one actuating means. The actuator element is movably mounted in an interface area of the preparation vessel which is configured for arrangement in a receiving area of a kitchen appliance base. The actuating means can be actuated by the actuator element wherein an actuation of the actuating means can cause the lid to be locked to the preparation vessel. At least one valve and at least one valve actuating means are provided and the valve actuating means can at least be indirectly or directly actuated with the actuating means.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a perspective view of an embodiment according to one aspect of the present disclosure of a kitchen appliance with a preparation vessel and a kitchen appliance base;

FIG. 2 shows a perspective view of an embodiment according to the teachings of the present disclosure of a kitchen appliance base;

FIG. 3 shows an embodiment of a preparation vessel in a first state;

FIG. 4 shows the embodiment of the preparation vessel according to FIG. 3 in a second state;

FIG. 5 shows another embodiment of a preparation vessel in a first state;

FIG. 6 shows an embodiment of the preparation vessel according to FIG. 5 in a second state;

FIG. 7 shows a perspective view of yet another embodiment according to the teachings of the present disclosure;

FIG. 8 shows a detailed view of an embodiment of a preparation vessel according to another aspect of the present disclosure;

FIG. 9 shows another embodiment of a preparation vessel according to the teachings of the present disclosure; and

FIG. 10 shows yet another embodiment of a preparation vessel.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the preparation vessel is configured and set up to be arranged on a kitchen appliance base. The kitchen appliance base is preferably provided with a housing having at least one receiving area, in particular for receiving a preparation vessel, at least one electrical motor, at least one weighing device, in particular in the receiving area, and/or a power supply.

In the state where it is mounted on the kitchen appliance base, the preparation vessel is used for automatically, semi-automatically, or manually preparing, for example, chopping, grinding, pressing, stirring, cooking, and/or keeping warm of food.

The preparation vessel, for example, has at least one interface area that is configured for arrangement in a kitchen appliance base, in particular for interacting in a form-fitting manner with a receiving area of the kitchen appliance base. At least one electrical interface is arranged, for example, in the interface area in order to supply the preparation vessel with a working voltage, for example, for a heating device or for contacting sensors in the preparation vessel. In the state where it is arranged in the receiving area, the electrical interface interacts with an electrical counter-interface of the kitchen appliance base.

It is furthermore provided, for example, that at least one working interface is arranged in the interface area of the preparation vessel, which is used for transmitting a torque from a working unit, for example, an electrical motor of the kitchen appliance base to a tool arranged on the preparation vessel.

The preparation space of the preparation vessel is preferably lined with metal or made of metal. The metal is preferably stainless steel. The preparation space can be closed with the lid by locking the lid to the preparation vessel. The preparation space is preferably pressure-tight once it has been closed with the lid and the lid is locked to the preparation vessel. For example, at least one seal is arranged between the lid and the preparation vessel, in particular on an upper edge of the preparation vessel.

The preparation vessel has at least one actuator element which is arranged in the interface area of the preparation vessel. The actuator element is in particular arranged in the interface area in such a way that it can be actuated, in particular movably actuated, by a driving means of the kitchen appliance base. The actuator element is preferably rotatably mounted. For example, the actuator element can be rotated by a drive means of the kitchen appliance base, for example by a drive ring, in particular by the drive means interacting in a form-fitting manner with the actuator element in the state where it is arranged on the kitchen appliance base. It is preferably provided that the driving means of the kitchen appliance base, which interacts with the actuator element or drives the actuator element, is configured as a rotatable drive ring, in particular with drive projections, as a gearwheel or as a translationally movable tooth bar.

The actuator element is operatively connected to the actuating means in such a way that the actuating means can be actuated by the actuator element, in particular at least in a temporary manner, preferably be moved or be rotated. In addition, the actuating means is configured and arranged in such a way that locking or unlocking the lid, in particular with an upper edge of the preparation vessel, can be realized by actuating, in particular moving or rotating, the actuating means. For this purpose, the actuating means acts indirectly or directly on the lid, or a locking element arranged on the preparation vessel or the lid, in order to lock or unlock the lid, in particular in a form-fitting manner.

It is thereby provided that the lid is rotated for locking or unlocking, or that a locking element is arranged on the lid or on the preparation vessel, which is rotatably mounted relative to the preparation vessel and/or the lid in order to lock or unlock the lid to or from the preparation vessel.

According to another aspect of the present disclosure, it is provided that the preparation vessel and/or the lid is provided with at least one valve, in particular a pressure valve or safety valve. The valve is arranged, for example, centrally in the lid or eccentrically on the lid, in particular in an edge region of the lid. A connection between the preparation space and the environment of the preparation vessel can be established with the valve. Furthermore, at least one valve actuating means with which the valve can be actuated is provided, that is, the valve can be opened and/or closed. It is provided that the valve is open or closed in the non-actuated state, so that it is either opened or closed when the valve actuating means is actuated. The valve is preferably closed in the non-actuated state and is partially or fully opened when actuated by the valve actuating means.

The actuating means is configured and arranged in such a way that the valve actuating means can also be indirectly or directly actuated at least temporarily with the actuating means. The valve can consequently be opened and/or closed indirectly or directly with the actuating means.

If the valve is a spring-loaded valve which is opened against the spring force by pulling out a valve slide, it is provided that the valve actuating means is configured, for example, as a valve actuating lever, which when lifted causes the valve slide to be pulled out against the spring force in order to allow pressure to escape from the preparation space.

Because the actuator element interacts with the actuating means and the lid can be locked or unlocked at least indirectly with the actuating means and the valve actuating means can likewise be actuated, a movement, in particular a rotation, of the actuator element—depending on the direction of movement or rotation—can cause the lid to be locked or unlocked and the valve actuating means to be actuated.

It is preferably provided that the actuator element, the actuating means, the locking means, and the valve actuating means are configured as mechanically actuated components, which are in an operative connection with one another due to their design and construction.

In an alternative embodiment, however, it is also provided that all or individual interactions are electromechanically designed. This means, for example, that individual interactions are configured via electrical actuating means, for example motors, in particular servomotors, stepper motors, and/or linear motors. A rotation of the actuator element caused by the kitchen appliance base for locking the preparation vessel to the kitchen appliance base is detected, for example, by at least one sensor, for example, a potentiometer, processed, and emitted as an actuating signal to an actuating means designed as a motor, in order to cause the lid to be locked and/or to actuate the valve actuating means, in particular via a mechanical connection to the motor. With this alternative, there is no requirement for mechanical components that bridge the distance between the interface area of the preparation vessel and the upper edge area of the preparation vessel. An interaction of the components can take place at least in part via an electrical signal transmission. The control is preferably carried out via a control unit provided in the kitchen appliance base. A user can operate the appliance, for example, via an operating device provided on the kitchen appliance base.

It is also provided that the actuating means has at least one motor and one actuating arm, wherein the actuating arm can be moved by means of the motor. The movement of the actuating arm causes—as described above and below for the actuating means—a locking of the lid to the preparation vessel and/or an actuation of the valve. The motor has a power supply through contact with the kitchen appliance base and/or at least one energy storage device, in particular so that the motor can be remotely controlled via an operating device arranged on the kitchen appliance base—independently of the arrangement on the kitchen appliance base—and/or via a pressure surface or an actuatable lever on the preparation vessel in order to lock or unlock the lid and/or actuate the valve.

The disclosure of the invention further comprises a preparation vessel to be arranged on a kitchen appliance base of a kitchen appliance having at least one preparation space, at least one lid for closing the preparation space, wherein at least one valve and at least one valve actuating means and/or at least one lid actuating means is/are provided. The valve actuating means is advantageously used to open and/or close the valve. It is also provided that at least one movement of the valve—opening or closing—is actuated by means of a spring force, while the other movement—opening or closing—is carried out by means of the valve actuating means. The lid actuating means is advantageously used for locking and unlocking the lid to or from the preparation vessel.

The valve actuating means and/or the lid actuating means in particular has an electrical actuating means, for example a motor, preferably a servomotor, a stepper motor, and/or a linear motor. The valve actuating means and/or the lid actuating means has, for example, a separate power supply, in particular one that can be contacted with the kitchen appliance base and/or an energy storage device for power supply, for example, at least one battery. For example, the valve actuating means and/or the lid actuating means can be supplied with power by the energy storage device when the preparation vessel is removed from the kitchen appliance base; in the state where the energy storage device is arranged on the kitchen appliance base, it can be charged via the contactable power supply and/or the valve actuating means and/or the lid actuating means can be supplied with power. It is preferably provided that the valve actuating means and/or the lid actuating means can be remotely controlled via a control unit of the kitchen appliance base, in particular independently from the arrangement on the kitchen appliance base. It is preferably provided that the valve actuating means and/or the lid actuating means can be actuated, for example, by a user via a pressure surface or an actuatable lever on the preparation vessel in order to let pressure escape via the valve.

In comparison to the prior art, the invention has the advantage that the actuation of the valve is integrated via the common actuating means in the especially mechanical interaction process between the lid and the preparation vessel. Depending on the embodiment, this ensures a valve actuation under predetermined boundary conditions. A preparation vessel according to the invention allows to prepare food in the preparation space under pressure while maintaining a high level of user safety.

According to a first embodiment of the preparation vessel, it is provided that the actuating means is at least in part rotatably mounted with the actuator element about a common first axis of rotation. The actuating means preferably has at least two actuating arms which are connected to the actuator element in such a way that they can be rotated together with the actuator element. The actuating arms are configured, for example, as one piece with the actuator element. In particular the actuating arms are arranged facing one another on the actuator element. If the actuator element is thus rotated about the first axis of rotation in a first direction or in a second direction, the actuating arms of the actuating means similarly rotate.

According to another aspect of the present disclosure, it is provided that the ends of the actuating arms facing away from the actuator element directly interact with the lid in order to lock it or interact with a locking means in order to lock the lid of the preparation vessel via the locking means. If the lid is directly actuated by the actuating arms, the lid is rotated, for example, about the first axis of rotation in order to lock to the preparation vessel, in particular in the manner of a bayonet lock.

It is further provided that the ends of the actuating arms facing away from the actuator element are in indirect or direct operative connection with the valve actuating means so that the valve actuating means can be actuated at least by sections by rotating the actuating arms about the first axis of rotation. The ends of the actuating arms facing away from the actuator element preferably interact in a form-fitting manner with the lid and/or the locking element.

The actuating arms extend, for example, away from the actuator element and have a transition area from where the actuating arms essentially extend vertical in direction of the lid or the opening of the preparation vessel.

It is preferably provided that at least one of the actuating arms, preferably both actuating arms, have at least one projection on the end facing away from the actuator element, and that the projection interacts with a guide groove in the locking means. The guide groove is configured and arranged in such a way that the locking means is actuated by the projection of an actuating arm when the respective actuating arm is in one of both outer edge areas of the guide groove. The length of the guide groove then determines, for example, an idle stroke of the actuator element or the actuating means. An idle stroke can, for example, be used for realizing a chronological order of different functions of the preparation vessel, for example, locking the preparation vessel to the kitchen appliance base is realized within the idle stroke. During an idle stroke, a movement of a first element in a mechanical chain of actions takes place without this movement being completely transferred in the chain of actions. Consequently, the chain of actions is interrupted at least temporarily. The valve actuating means is preferably provided in an operative interaction with the locking means.

According to an alternative embodiment of the preparation vessel, it is provided that the actuating means can at least partially rotate about a second axis of rotation. The second axis of rotation is preferably different from a first axis of rotation of the actuator element. The actuator element and the actuating means rotatable about the second axis of rotation are preferably mechanically coupled in such a way that the actuating means can be rotated about the second axis of rotation with a movement, in particular rotation, of the actuator element.

The actuating means, for example, has at least one actuator shaft which can be rotated by means of a movement, in particular a rotation, of the actuator element. The actuating means which is rotatable about the second axis of rotation, in particular the actuator shaft, interacts indirectly or directly with the lid and/or a locking element in order to lock the lid to the preparation vessel. Furthermore, the actuating means, in particular the actuator shaft, which can rotate about the second axis of rotation is in operative connection with the valve actuating means so that the valve actuating means can be actuated by means of a rotation of the actuating means, in particular of the actuator shaft.

According to an especially preferred embodiment of the preparation vessel, it is provided that the actuating means interacts with at least one locking means in order to lock the lid to the preparation vessel. The locking means can be moved by the actuating means at least between a release position and a locking position. The locking means can also preferably be moved by the actuating means into an actuating position for the valve actuating means.

In the release position, the lid can be placed onto or removed from the preparation vessel. In the locking position, the lid—if present—is locked in a form-fitting manner to the preparation vessel by the locking means. The locking means surrounding the opening to the preparation vessel is preferably mounted in a rotatable manner. For example, the locking means is configured as a locking ring, in particular with locking projections. By rotating the locking means, the locking projections of the locking means slide under corresponding projections on the lid, whereby the lid is locked to the preparation vessel. The lock between the preparation vessel and the lid is preferably configured by the locking means in the manner of a bayonet lock.

It is especially provided that the locking means is in operative connection with the valve actuating means, so that the valve actuating means is at least actuated or can be actuated in certain positions of the locking means.

According to another embodiment of the preparation vessel, it has proved advantageous if at least one intermediate element is provided, and the intermediate element can indirectly or directly be moved, in particular displaced, by a movement of the actuating element. The actuating element has, for example, at least one rotatable actuator shaft, whose rotation causes a movement of the intermediate element. The intermediate element is preferably arranged in the upper edge region of the preparation vessel. The intermediate element is preferably translationally or rotatably movably mounted. The intermediate element is in particular movably held on a circular segment over the outer circumference of the preparation vessel.

The locking means is preferably in operative connection with the intermediate element in such a way that the locking means can be moved by the intermediate element at least between a release position and a locking position. In the release position, the lid can be attached or removed; in the locking position, the lid is locked to the preparation vessel when the lid is present. It is also provided that the valve actuating means can be actuated by the intermediate element at least in one actuating position of the intermediate element. Consequently, both the lid can be locked to the preparation vessel and the valve actuating means can be actuated at least in one actuating position with a movement of the intermediate element caused by the actuating means or by a movement of the actuating means. The movement of the actuating means is caused by the actuator element.

In order to actuate the valve actuating means with the intermediate element in the actuating position, it has turned out to be advantageous according to a further embodiment if the intermediate element is provided with a contact slope, in particular at least at one end. The valve actuating means can be actuated with the contact slope. The valve actuating means preferably has a mating contact slope so that when the valve actuating means is moved toward the intermediate element, the mating contact slope slides off the contact slope, thereby moving the valve actuating means—at least partially—in a predetermined direction and/or lifting the valve actuating means in lever-like manner at one end. The valve is actuated, in particular opened, due to the actuation of the valve actuating means caused by the contact slope.

A further embodiment of the preparation vessel provides that the intermediate element is held in a guide contour in a movable manner. The intermediate element is held translationally in the guide contour or rotatably on a circular path, in particular about the first axis of rotation X1. For this purpose, the intermediate element is configured in arc shape. The guide contour is configured on its outer side, for example, as a handle element to enable the preparation vessel to be gripped by a user. The guide contour, for example, has at least one grip recess on the outer side.

In order to be able to advantageously move the intermediate element in a simple manner, it is provided according to a further embodiment that the intermediate element has at least one tooth bar for interacting with the actuating means. The actuating means is configured and arranged in such a way that it can cause a movement of the intermediate element by interacting with the tooth bar of the intermediate element, preferably on a circular path around the first axis of rotation X1.

An interaction between the actuating means and the intermediate element is especially improved according to a further embodiment in that the actuating means has at least one first tooth ring and at least one second tooth ring. The first tooth ring is arranged such that it can interact with the actuator element, in particular such that a movement of the actuator element causes a rotation of the tooth ring. The rotation of the first tooth ring preferably causes a rotation of at least one part of the actuating means, whereby the second tooth ring of the actuating means, which is arranged at the end of the actuating ring facing away from the actuator element, likewise rotates.

The second tooth ring preferably engages in the tooth bar of the intermediate element so that a rotation of the actuating means over the first tooth ring and the second tooth ring causes a displacement of the intermediate element along the circular path. Due to the displacement of the intermediate element—depending on the direction of rotation of the actuating means—for example, the lid is locked or unlocked with the preparation vessel and—at least in one actuating position of the intermediate element—the valve actuating means is actuated.

According to yet another aspect of the present disclosure, it is provided that the first tooth ring and the second tooth ring have different gearing properties in order to implement a translation. The first tooth ring and the second tooth ring, for example, have a different number of teeth so that a translation between the actuator element and the intermediate element can be implemented by the actuating means. Depending on the number of teeth for the first tooth ring and for the second tooth ring, the intermediate element moves faster or slower than the actuator element. For example, a large actuating movement of the intermediate element can be implemented with only a small actuating movement of the actuator element, or an only minor actuating movement of the intermediate element can be implemented with a large actuating movement of the actuator element.

A form-fitting interaction between the actuator element and the actuating element is especially preferred. According to a further embodiment, it is advantageously provided for this purpose that the actuator element has at least one actuator tooth bar, and that the actuating means at least temporarily engages with the first tooth ring in the actuator tooth bar. The actuator tooth bar is moved, for example, in a translational or rotatory manner in order to move the actuating means or transfer the movement to the actuating means. The movement of the actuator tooth bar preferably causes a rotation of the first tooth ring of the actuating means, in particular a rotation of the actuator shaft connected to the first tooth ring. It is also provided that the actuator element is configured as a gearwheel that causes a movement of the tooth ring of the actuating means.

In order to realize a mechanically dependent, chronological sequence of the interaction of the components of the preparation vessel, it is preferably provided according to a further embodiment of the preparation vessel that the actuator tooth bar comprises at least one first tooth bar section and at least one second tooth bar section. The tooth bar sections are spaced apart from one another by at least one intermediate area. It is preferably provided that no force can be transmitted in the intermediate area by the actuator element to the actuating means, in particular in order to realize an idle stroke of the actuator element by means of the intermediate area. For this purpose, the intermediate area is configured, for example, tooth-free or has a gearing that cannot cause a rotation of the first tooth ring.

During the idle stroke, for example, the actuator element continues to move without causing a movement of the actuating means or a movement of the intermediate element. A movement of the actuating means or of the intermediate element is only produced when the movement of the actuator element has advanced so far that the actuating means interacts with the second tooth bar section or, in case of an opposite movement, when it again interacts with the first tooth bar section.

It is preferably provided that a locking of the lid with the preparation vessel is realized with a movement of the actuator element in the area of the first tooth bar section, for example, in that the intermediate element moves the locking means into the locking position to lock the lid to the preparation vessel. In the area of the idle stroke preferably occurs a form-fitting locking of the preparation vessel to the kitchen appliance base. A movement of the actuator element preferably causes a displacement of the intermediate element when the second tooth bar section interacts with the actuating means so that the contact slope of the intermediate element interacts with the contact slope of the valve actuating means in order to open the valve. The valve can likewise be closed with a movement in the opposite direction.

To particularly prevent an unintentional detachment of the preparation vessel from a kitchen appliance base, it is provided according to a further embodiment that the actuator element has at least one locking contour, and that the locking contour is configured for interacting with a mating locking contour on the kitchen appliance base. The locking contour and the mating locking contour preferably interact in a form-fitting manner with one another. Particularly the locking contour and the mating locking contour interact in the manner of a bayonet locking, for example, by moving the locking contour relative to the mating locking contour. The actuator element is preferably provided with a plurality of locking projections as a locking contour which interacts with locking hooks as a mating locking contour on the kitchen appliance base.

The mechanical or electromechanical interaction of the actuator element, the actuating means, and the locking means and the valve actuating means is particularly preferably coordinated in such a way that the lid is first locked to the preparation vessel when the actuator element is moved in a first direction, and subsequently in particular the preparation vessel is locked to a kitchen appliance base. The valve actuating means can subsequently be actuated, or the valve remains unactuated. Likewise, when the actuator element is moved in an opposite second direction, the locking between the preparation vessel and the kitchen appliance base is preferably released. The preparation vessel can then either be removed with the locked lid from the kitchen appliance base, or the actuator element causes the lid to unlock, for example, by moving the locking means from its locking position to its release position.

It is advantageously provided that the preparation vessel has at least one confirmation means with which the locking of the lid to the preparation vessel and/or of the preparation vessel to the kitchen appliance base and/or a position of the valve can be verified and/or confirmed. The confirmation means is arranged and configured for checking and confirming the correct position of all interacting components or part thereof. The confirmation means, for example, has a torque measurement and or current measurement of a motor in the kitchen appliance base and or at least a switch that can be actuated by the moved actuator element, the moved actuating means, the intermediate element, the locking means, the valve actuating means, and/or the lid. A working voltage at the electrical interface for the preparation vessel and/or a movement at the working interface of the kitchen appliance base for the preparation vessel can be released, for example, by using at least one signal of the confirmation means.

In order to prevent an accidental opening of the lid when pressure is present in the preparation space, it is provided according to a further embodiment that at least one safety device is provided, which is arranged and configured to prevent the lid from being opened as long as a threshold value of a pressure is exceeded in the preparation space. The lid preferably cannot be released as long as the pressure in the preparation space is greater than or equal to 2 kPa, in particular greater than or equal to 4 kPa, or greater than or equal to 4 kPa.

It is further provided that the safety device is configured so that the lid moves slightly upward when pressure is present in the preparation space, wherein this movement is used to block an opening movement of the lid and/or the locking means that prevents, for example, the locking means from being moved from the locking position to the release position, or the lid from being rotated so that it reaches its release position.

It is additionally provided that the safety device has, for example, a weight valve that prevents a movement of the locking means, the intermediate element coupled to the locking means, and/or the lid into the release position, as long as a pressure predetermined by the design of the weight valve prevails in the preparation chamber.

It is furthermore provided that the safety device is configured so that the intermediate element has an at least partially movable extension which interacts with a weight valve arranged in the lid. Provided the weight valve is in an outwardly protruding position due to the pressure, the intermediate element cannot be moved past the weight valve, whereby an unlocking of the lid is prevented. It is preferably provided that a flap movement of the extension is realized by a cam mechanism.

For the case in which a user removes the pressurized, locked preparation vessel from a kitchen appliance base, it has proven advantageous according to a further embodiment if it is provided that the valve actuating means and/or the actuating means are/is arranged and configured to be operated manually by a user. It is preferably provided that the valve actuating means can be accessed by a user, for example as a pressure surface or actuatable lever in order to let pressure escape via the valve. It is further provided that the actuating means especially, for example, an actuator shaft or at least an actuating arm, can be accessed by a user to manually rotate, for example, an actuator shaft in order to actuate the valve actuating means, for example, via the intermediate element, and allow the pressure to escape via the valve. For this purpose, the actuating means has, for example, an adjusting wheel that can be rotated by the user or another actuating element.

If the valve is a spring-loaded valve which is opened against the spring force by pulling out a valve slide, it is provided that the valve actuating means is configured, for example, as a valve actuating lever, which when lifted causes the valve slide to be pulled out of the guide against the spring force in order to allow pressure to escape. It is additionally provided that the valve is configured, for example, as a weight valve, where the weight closes an opening to the inside of the vessel in its natural position due to the contact geometry and gravity. In case of a sufficiently high inner pressure, the valve is lifted, and the pressure can escape. The weight can likewise also be lifted via a valve actuating lever.

The objective mentioned at the beginning is further attained with a kitchen appliance having at least one kitchen appliance base and at least one preparation vessel according to any one of the exemplary embodiments described above. The preparation vessel can be arranged with its interface area in a receiving area on the kitchen appliance base. The kitchen appliance base preferably has a driving means for interacting, in particular in a form-fitting manner, with the actuator element of the preparation vessel in the state where it is arranged in the receiving area.

The driving means of the kitchen appliance base is configured, for example, as a drive ring with two projections. These projections interact in the attached state with corresponding recesses in the actuator element so that a movement of the drive ring of the kitchen appliance base causes an identical movement of the actuator element, here a rotation.

A further embodiment provides that the preparation vessel has at least a lining. The lining extends over the complete circumference or part of the circumference of the preparation vessel and especially forms at least part of the external surface of the preparation vessel. The lining extends, for example, over part of the height or the entire height between the upper edge of the preparation vessel and a bottom area of the preparation vessel. The lining forms in particular at least a part of a double-walled construction. The actuating means and/or the actuator means, and/or the locking means, and/or the intermediate element are/is in particular, at least partially or completely covered by the lining or is/are arranged in an intermediate space of the double-walled construction. The lining has, for example a thermally insulating material or is made of such a material.

Further advantageous embodiments of the invention arise from the following description of the figures and the dependent claims.

In the various figures of the drawing, identical parts are consistently provided with the same reference numerals.

Regarding the following description, it is claimed that the invention is not limited to the exemplary embodiments, and is thus not limited to all or several features of the described feature combinations, rather each individual partial feature of the/each exemplary embodiment is also relevant to the subject matter of the invention detached from all other partial features described in connection therewith for itself and also in combination with any features of another exemplary embodiment.

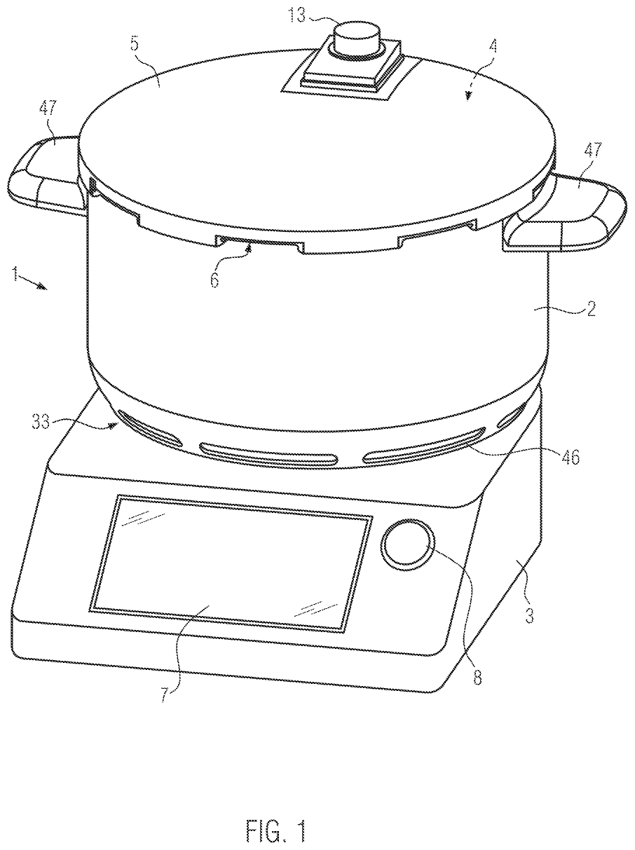

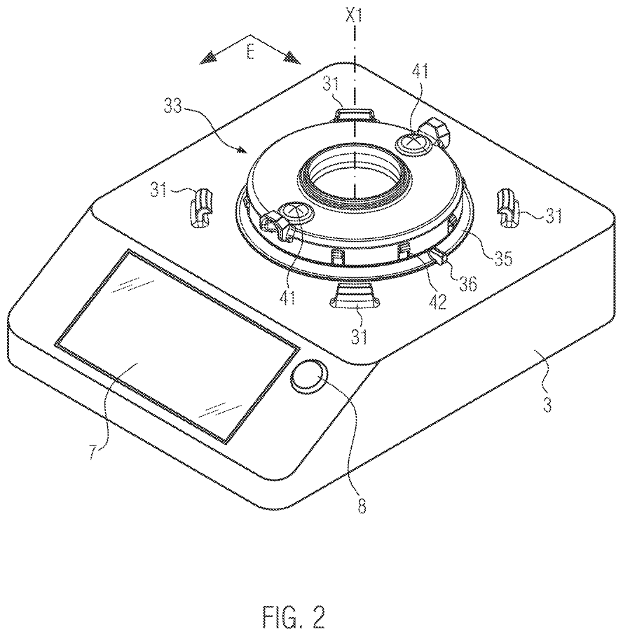

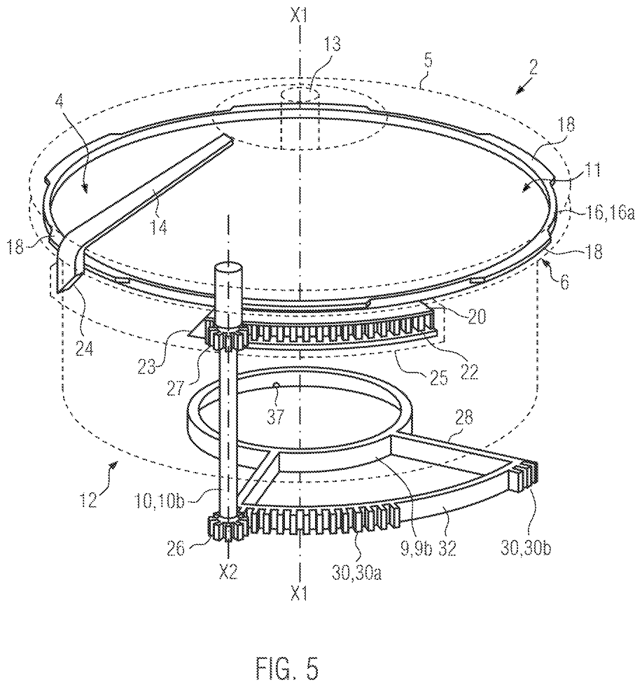

FIG. 1 shows an exemplary embodiment of a kitchen appliance 1 having a preparation vessel 2 and a kitchen appliance base 3. FIG. 2 shows an exemplary embodiment of a kitchen appliance base 3 according to FIG. 1 without preparation vessel 2. According to FIG. 1, the preparation vessel 2 is arranged on the kitchen appliance base 3. The preparation vessel 2 has a preparation space 4 that can be closed by a lid 5 in order to, for example, cook food under pressure inside the preparation space 4. A seal—not shown—is arranged, for example, between the lid 5 and the upper edge 6 of the preparation vessel 2. The lid 5 and the preparation vessel 2 can be locked to one another via a bayonet lock, in particular in that the lid is moved relative to the preparation vessel 2, or via a locking means 16, for example, a locking ring 16a—refer, for example, to FIG. 5—that is moved relative to the preparation vessel 2 and to the lid 5. The lid has a valve 13 which is arranged in the edge region. According to FIG. 1 and FIG. 2, the kitchen appliance base 3 has an operating and display device 7, and an input means 8. The preparation vessel 2 has a lining 43 arranged over the entire circumference, and two carrying handles 47 arranged opposite to one another.

According to FIG. 2, the receiving area 33 has an electrical interface, which in this exemplary embodiment has two power contacts 41, for example, for contacting at least one heating device, and eight signal contacts 42, for example for contacting sensors, in particular thermoelements. The receiving area 33 essentially extends within the plane E.

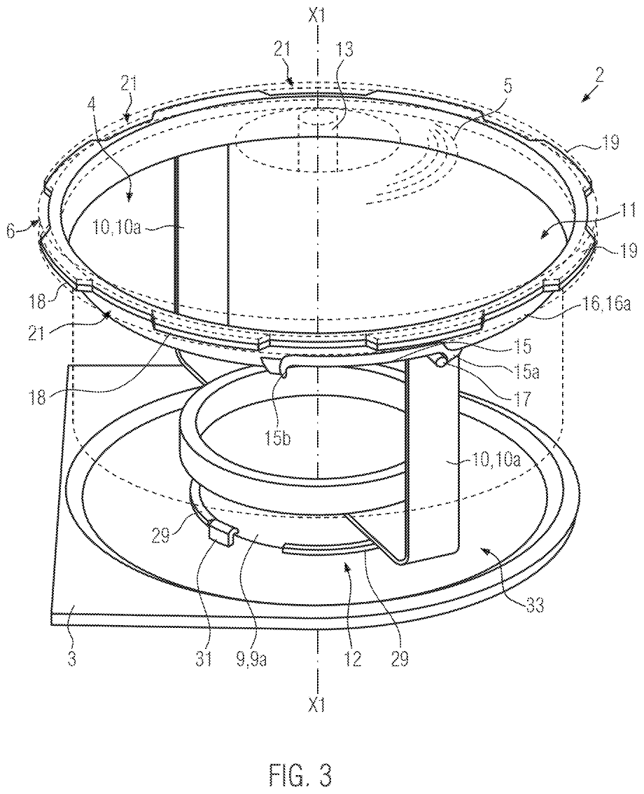

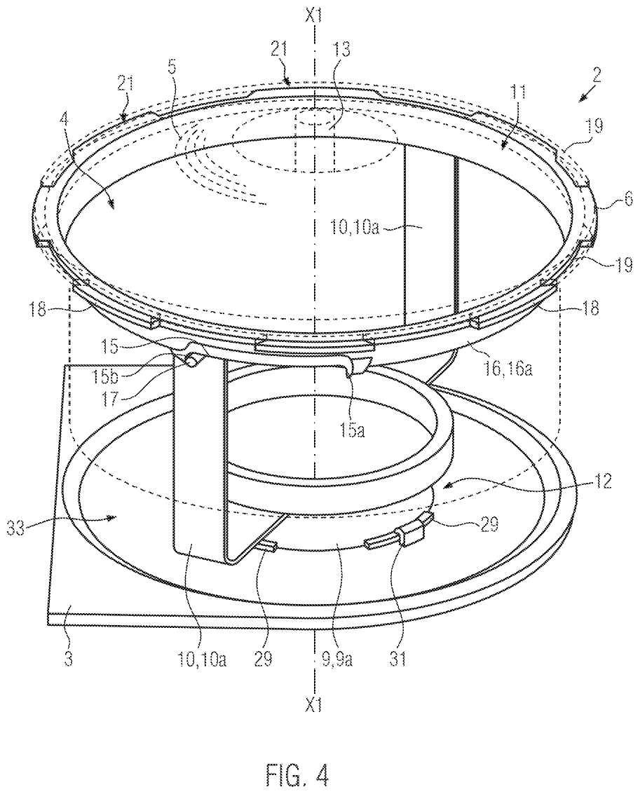

FIG. 3 and FIG. 4 show an exemplary embodiment of a preparation vessel 2 represented at least in part transparent in a first state—FIG. 3—and in a second state—FIG. 4. For reasons of a better overview, some parts of the preparation vessel are only shown schematically or transparently in FIGS. 3 and 4. The kitchen appliance base 3 is only shown partially in FIGS. 3 and 4.

The preparation vessel 2 according to FIG. 3 and FIG. 4 has a lid 5, with which the preparation space 4 can be closed. The preparation vessel 2 has an actuator element 9 and an actuating means 10. Here, the actuator element 9 is designed as an actuator ring 9a configured as one piece with the actuating means 10. In this exemplary embodiment, the actuating means 10 has two actuating arms 10a, which extend opposite to one another emanating from the actuator element 9 and configured as one piece with the actuator element 9. Emanating from the actuator element 9, the actuating arms 10a initially essentially extend horizontally outward, and in a subsequent region approximately vertically upward toward an opening 11 of the preparation vessel 2. The actuator element 9 is essentially configured ring-shaped and arranged in an interface area 12 that is configured to be arranged on a kitchen appliance base 3—refer to FIGS. 1 and 2. The actuator element 9 is rotatably arranged about a first axis of rotation X1 on the preparation vessel 2.

Because the actuating means 10 in the form of the actuating arms 10a is configured as one piece with the actuator element 9, the actuating means 10 can be actuated directly, in this case moved, by the actuator element 9. The lid 5 can be locked and unlocked with the preparation vessel 2 by actuating the actuating means 10 with the actuator element 9.

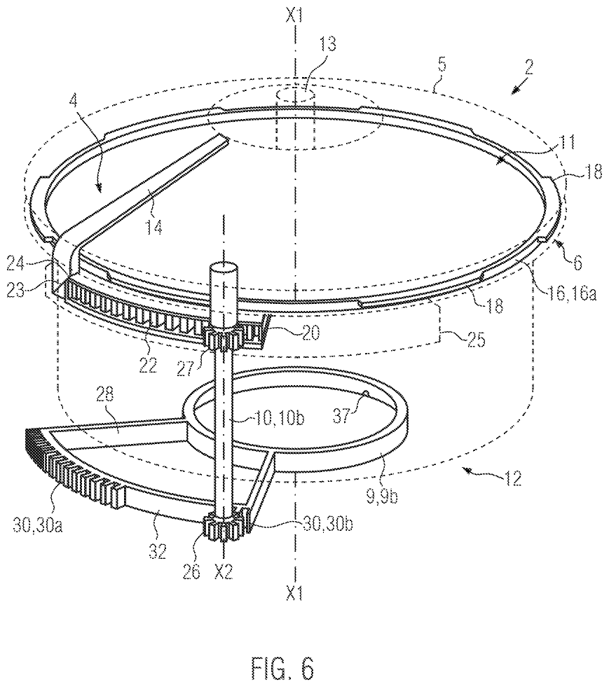

The preparation vessel 2 further has a valve 13 arranged centrally in the lid 5, with which a pressure in the preparation space 4 can be regulated. The preparation vessel 2 additionally has a valve actuating means 14, depicted as an example in FIGS. 5 and 6, with which the valve 13 can be opened. The valve actuating means 14 is operatively connected to the actuating means 10 and thus also to the actuator element 9. The valve 13 can consequently be actuated by rotating the actuator element 9 via the valve actuating means 14.

Unlocking or locking between the lid 5 and the preparation vessel 2 is realized in that the actuating arms 10a of the actuating means 10 interact in a form-fitting manner with a guide groove 15 in a locking means 16 configured as a locking ring 16a. The locking means 16 is rotatably arranged on the upper edge 6 surrounding the opening 11 to the preparation space 4 and can, for example, be rotated between a release position shown in FIG. 3 and a locking position shown in FIG. 4.

In order to rotate the locking means 16, each of the actuating arms 10a is provided with a projection 17, which interacts positively with the guide groove 15. According to FIG. 3, the projection 17 rests against a first stop edge 15a, whose interaction with the projection 17 causes the locking means 16 to be rotated into the release position shown. According to FIG. 4, the projection 17 rests against a second stop edge 15b, whose interaction with the projection 17 caused the locking means 16 to be rotated into the release position shown in FIG. 4.

In order to lock the lid 5 o the preparation vessel 2, the locking means 16 according to FIG. 3 and FIG. 4 has locking projections 18 which are aligned so as to substantially overlap with edge projections 19 of the preparation vessel 2 in the release position according to FIG. 3, so that locking regions of the lid 5, which are not shown here, can be inserted into the intermediate regions 32. If the locking projections 18 are subsequently pivoted into the region of the intermediate spaces 20 (refer to FIG. 4), the lid 5 is locked in a form-fitting manner to the preparation vessel 2.

FIGS. 5 and 6 show a perspective view of an exemplary embodiment of a preparation vessel 2 in two different states. For reasons of better overview, some parts of the preparation vessel are only shown schematically or transparently in FIGS. 5 and 6. The edge projections 19 of the preparation vessel 2—refer to FIGS. 3 and 4—in particular are not shown. The preparation vessel 2 likewise has a locking means 16 in the form of a locking ring 16a which is rotatably mounted on the upper edge 6 of the preparation vessel 2. The locking ring 16a is also rotatably mounted in this exemplary embodiment and has locking projections 18 for interacting in a form-fitting manner with corresponding edge projections—not shown in FIGS. 5 and 6—of the lid 5.

According to another aspect of the present disclosure, the embodiment of FIGS. 5 and 6 provides an arc-shaped intermediate element 20 which is rotatably mounted on a circular path about the first axis of rotation X1. The intermediate element 20 is mechanically operatively connected to the actuating means 10 which has an actuator shaft 10b in this exemplary embodiment. The actuator shaft 10b can be rotated about a second axis of rotation X2 which is different from the first axis of rotation X1. When the intermediate element 20 is moved, the locking element 16 is likewise moved. Merely starting at the initial position in FIG. 5 does the intermediate element 20 have a short idle movement during which the locking means 16 is not moved.

The locking means 16, in particular the locking ring 16a, can be moved by the intermediate element 20, among others into the locking position shown in FIG. 6. At an end pointing toward the valve actuating means 14, the intermediate element 20 has a contact slope 23 by means of which the valve actuating means 14 can be actuated. For the actuation, the valve actuating means 14 is provided in this exemplary embodiment with a mating contact slope 24 that slides off the contact slope 23 when the intermediate element according to FIG. 6 is moved toward the mating contact slope 24. The valve actuating means 14 is actuated, in this case pressed upwards, by sliding off the mating contact slope 24 on the contact slope 23. The valve 13 is opened and pressure can escape to the outside from the preparation space 4 in that the valve actuating means 14 is actuated. The intermediate element 20 is movably mounted in a guide contour 25, which extends outward starting from an outer circumference of the preparation vessel 2 that is not shown to likewise be used as a handle element on the outside of the preparation vessel 2.

In order to enable an interaction with the actuating means 10, the intermediate element 20 according to FIGS. 5 and 6 is provided with a tooth bar 22. The actuating means 10, shaped here as an actuator shaft 10b, has a first tooth ring 26 and a second tooth ring 27 which are mounted spaced apart from one another on the actuator shaft 10b. The actuator element 9 is shaped here as a tooth actuator element 9b configured as one piece with an outer frame 28 having an actuator tooth bar 30. The actuator element 9 likewise interacts positively with the actuating means 10, here the actuator shaft 10b, in that the actuator element 9 has an arc-shaped actuator tooth bar 30 arranged on an outer frame 28. The outer frame 28 preferably has substantially the shape of a ring surface segment. The actuator tooth bar 30 interacts with the first tooth ring 26 in such a way that the first tooth ring 26 is likewise rotated when the actuator element 9 is rotated. The rotation of the actuating means 10 or of the actuator shaft 10b also causes the second tooth ring 27 to rotate, which interacts with the tooth bar 22 of the intermediate element 20 and thereby displaces the intermediate element 20 according to FIGS. 5 and 6. The intermediate element 20 also moves the locking means 16 during the displacement.

The tooth bar 30 of the actuator element 9 has a first tooth bar section 30a and a second tooth bar section 30b, which are arranged spaced apart from one another by a tooth-free intermediate region 32. The first tooth bar section 30a is longer than the second tooth bar section 30b. The lid 5 is locked to the preparation vessel 2 as a result of the interaction of the first tooth bar section 30a of the tooth bar 30 with the first tooth ring 26 and a resulting movement of the intermediate element 20 or the locking means 16. If the actuator element 9 moves further in the first direction, the tooth-free intermediate region 32 follows, which causes no further rotation of the first tooth ring 26 and thus also no further movement of the intermediate element 20.

When the first tooth ring 26 according to FIG. 6 is located at the end of the first tooth bar section 30a pointing toward the second tooth bar section 30b, the contact slope 23 of the intermediate element 20 preferably rests against the mating contact slope 24 of the valve actuating means 14. However, the valve 13 has as yet not been actuated. Only when the first tooth ring 26 interacts with the second tooth bar section 30, the intermediate element will be displaced further toward the valve actuating means 14, whereby the valve actuating means 14 is actuated. The second tooth bar section 30b is consequently used to actuate the valve actuating means 14 by means of the intermediate element 20.

According to the embodiment of FIGS. 3 and 4, the preparation vessel 2 is also locked to the kitchen appliance base 3 when the actuator element 9 is moved. For this purpose, the actuator element 9 has a locking contour 29, in this case in the form of locking projections. The locking contours 29 are configured for interacting with mating locking contours 31 on the kitchen appliance base 3, which are configured here as locking hooks. FIG. 3 shows the unlocked state in which the preparation vessel 2 can be arranged in the receiving area 33 of the kitchen appliance base 3. The locking contours 29 are arranged between the mating locking contours 31. When the actuator element 9 is rotated, the locking contours 29 are pivoted under the mating locking contours 31 so that they interact in a form-fitting manner and lock the preparation vessel to the kitchen appliance base 3. It is then no longer possible to remove the preparation vessel 2 from the kitchen appliance base 3.

The mating locking contours 31 of the kitchen appliance base 3 are also shown, for example, in FIG. 2. FIG. 2 further shows the drive means 35 of the kitchen appliance base 3, which is configured here as a rotatable drive ring with drive projections 36. The drive projections 36 can interact in a form-fitting manner, for example, with recesses 37, shown in FIGS. 5 and 6, in the actuator element 9 to transfer a movement of the drive means 35, here a rotation, to the actuator element 9 when the preparation vessel 2 is arranged in the receiving area 33 of the kitchen appliance base 3.

According to the embodiments of FIGS. 3 and 4, the mechanical operative interaction takes place as follows: In the initial position shown in FIG. 3, the preparation vessel 2 is not locked to the kitchen appliance base 3, and the lid 5 also rests unlocked on the upper edge 6 of the preparation vessel 2. The projection 17 rests against the first stop edge 15a of the guide groove 15. When the actuator element 9 is moved in clockwise direction—first direction—by a drive means 35, as shown, for example, in FIG. 2, the projection 17 is moved within the guide groove 15 along the length of the guide groove 15 without the locking means 16 being actuated. At the same time, the locking contours 29 of the actuator element 9 are moved toward the mating locking contours 31 of the kitchen appliance base 3. At the moment when the protrusion 17 comes into contact with the second stop edge 15b of the guide groove 15 during rotation, the locking contours 29 are transitioning into locking with the mating locking contours 31 on the kitchen appliance base 3.

From the moment the projection 17 contacts the second stop edge 15b, the locking means 16 is moved from its release position according to FIG. 3 toward its locking position according to FIG. 4. At the same time, the locking contours 29 are also engaged with the mating locking contours 31, so that the preparation vessel 2 is locked to the kitchen appliance base 3. Starting from the position shown in FIG. 4, the locking means 16 could be moved further by means of another clockwise rotation of the actuator element 9. The valve actuating means 14 would thus be actuated and the valve 13 opened. This further movement would have no influence on the locking of the lid 5 to the preparation vessel 2, or on the locking of the preparation vessel 2 to the kitchen appliance base 3.

If, starting from the position shown in FIG. 4, the actuator element 9 is moved in counterclockwise direction—second direction —, the locking means 16 is initially not moved since the projection 17 moves along the length of the guide groove 15 toward the first stop edge 15a. However, while the projection 17 moves within the guide groove 15, the locking contours 29 are moved out of engagement with the mating locking contours 31. At approximately the time when the projection 17 comes into contact with the first stop edge 15a, the locking contour 29 is pivoted out of engagement with the mating locking contour 31 so that the preparation vessel 2 can be removed from the kitchen appliance base 3 with the lid 5 locked at the same time. This can be done, for example, to allow a food present in the preparation space 4 to continue cooking under pressure independently from the kitchen appliance base 2.

However, if the preparation vessel 2 is left on the kitchen appliance base 3, the projection 17 acts against the stop edge 15a, whereby the locking element 16 is moved counterclockwise so that the lid 5 can be removed when the release position according to FIG. 3 is reached.

In an alternative embodiment according to FIGS. 3 and 4, the preparation vessel 2 is not locked to the kitchen appliance base 3, but the lid 5 is merely locked to the preparation vessel 2. The guide groove 15 can be shorter in this exemplary embodiment to realize an idle stroke.

In the embodiment of FIGS. 5 and 6, the mechanical operative interaction takes place as follows: When the preparation vessel 2 is placed on a kitchen appliance base 3, as shown, for example, in FIG. 2, the drive projections 36 engage in the recesses 37 at the actuator element 9 to also move the actuator element 9 when the drive means 35 is rotated. Starting at the initial position shown in FIG. 5, where the preparation vessel 2 is arranged in the receiving area 33 of the kitchen appliance base 3, the lid 5 is not locked to the preparation vessel 2 and the preparation vessel 2 is also not locked to the kitchen appliance base 3. If the actuator element 9 is now moved in clockwise direction—first direction —, the first tooth bar section 30a of the tooth bar 30 causes a rotation of the actuator shaft 10b via the first tooth ring 26, which causes a movement of the intermediate element 20 via the second tooth ring 27. The intermediate element 20 is coupled to the locking means 16 in such a way that there is still no movement of the locking means 16 at the beginning of the movement of the intermediate element 20, but the intermediate element 20 interacts with some delay with the locking means 16. The actuator element 9 and the intermediate element 20 are each preferably rotated by about 5° without the intermediate element 20 causing a movement of the locking means 16.

At the moment of the interaction of the intermediate element 20 with the locking means 16, the locking means 16 is moved clockwise by the intermediate element 20 which is essentially also moving clockwise. If the first tooth ring 26 has reached the end of the first tooth bar section 30a, the locking means 16 is in such a position that the lid 5 is locked to the preparation vessel 2. At this moment, the contact slope 23 also abuts against the mating contact slope 24 of the valve actuating means 14 without actuating it. For sweeping over the first tooth bar section 30a, the actuator element 9 is preferably moved by about 35°. The intermediate element 20 likewise moves as a result by about 35°. The locking means 16 is in particular only moved by about 30° due to the initially delayed entrainment.

If the actuator element 9 is moved further in clockwise direction—first direction —, the second tooth ring 27 is located in the tooth-free intermediate area 32 so that even though a further rotation of the actuator 9 takes place, the actuating means 10 is, however, not rotated further. In this section preferably a locking of the preparation vessel to the kitchen appliance base 3 through a rotation of the actuator element 9 as described, for example, regarding FIGS. 3 and 4 takes place. In order to sweep over the tooth-free intermediate area 32, the actuator element 9 is preferably moved by a further 30°, thus by a total of 65°. At the end of the tooth-free intermediate area 32, the first tooth ring 26 engages into the second tooth bar section 30b, whereby the intermediate element 20 is moved further. Since the contact slope 23 already abuts against the mating contact slope 24, the valve actuating means 14 is actuated and the valve 13 is opened. The second tooth bar section 30b is consequently used for opening and closing the valve 13 via the valve actuating means 14. The actuator element 9 is preferably moved by about a further 5° to sweep over the second tooth bar section 30b and actuate the valve. In order to actuate the valve, the actuator element 9 is preferably pivoted by about 70° from its initial position. In the state in which the valve 13 is open, the preparation vessel 2 is completely locked to the kitchen appliance base 3, the lid 5 is likewise locked to the preparation vessel 2 and, a preparation step, for example, can be carried out, in particular, a heating device arranged in the preparation vessel 2 can be switched on, or a tool can be operated.

A locking of the lid 5 to the preparation vessel 2 and of the preparation vessel 2 to the kitchen appliance base 3, can be confirmed, for example, via a confirmation means, which is not shown. The confirmation means is preferably configured to electromechanically detect a stop of the locking means 16 against the lid 5, for example, via a torque measurement/current measurement of a motor in the kitchen appliance base 3 that drives the drive means 35. It is in particular provided that the confirmation means detects the overtravel of a switch—not shown—by the intermediate element 20, the locking means 16, or another component in the mechanical chain in at least one predetermined position.

To subsequently allow pressure to build up in the preparation space 4, the valve 13 can be closed by rotating the actuator element 9 in counterclockwise direction—second direction—so that a force is no longer exerted by the contact slope 23 on the mating contact slope 24. For example, if the actuator element 9 is moved further in counterclockwise direction, an interlock between the preparation vessel 2 and the kitchen appliance base 3 is released in the tooth-free intermediate area 32. At the end of the tooth-free intermediate area 32 in the direction of the first tooth bar section 30a, the lid 5 is thus further locked to the preparation vessel 2, but the vessel cannot be removed from kitchen appliance base 3, for example, in order to allow further cooking or resting or pressure. If the vessel is left on the kitchen appliance base 3, the interaction of the first tooth bar section 30a via the actuator shaft 10b and the actuator element 9 causes the locking means 16 to move from the locking position to the release position when the actuator element 9 is rotated counterclockwise, so that the lid 5 can be removed at the end from the preparation vessel 2.

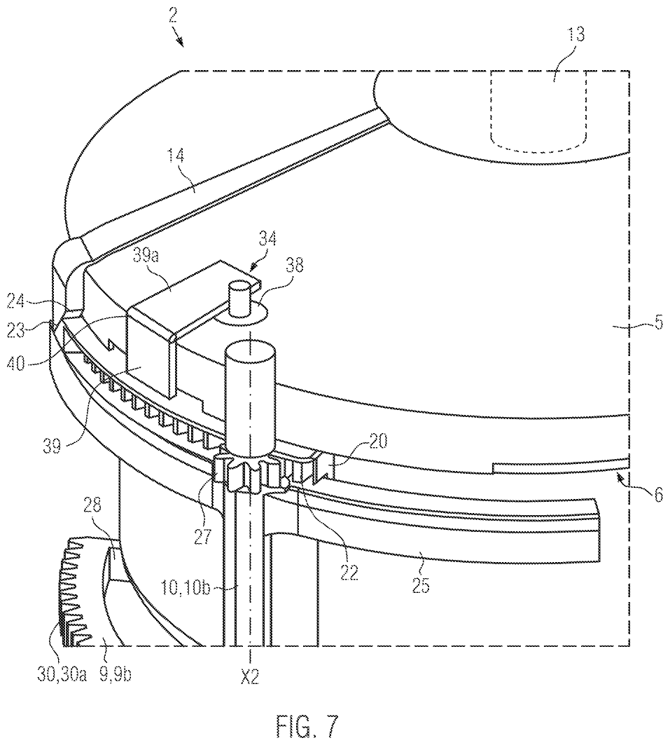

A safety device 34 is preferably provided in the exemplary embodiment according to FIG. 7 to ensure that the lid 5 can only be unlocked when the pressure inside the preparation space 5 is below an uncritical threshold, for example, of 4 kPa. The safety device 34 has a weight valve 38 as well as a foldable extension 39 of the intermediate element 20. The foldable extension 39 has a hinge 40 between two sections so that a pivotable section 39a can be moved. If the intermediate element 20 is moved toward the valve actuating means 14, the pivotable section 39a is preferably arranged so that it does not interact with the weight valve 38. As soon as the intermediate element 20 reaches the position shown in FIG. 7 in which the contact slope 23 rests against the mating contact slope 24, the pivotable section 39a is moved to the folded down position according to FIG. 7 via a cam mechanism—not shown—so that the foldable section 39a of the expansion 39 can interact with the weight valve 38.

As long as the weight valve 38 protrudes from the lid 5, the intermediate element 20 cannot be moved to unlock the lid 5. Only when the weight valve 38 disappears flush in the lid 5 when the pressure in the preparation vessel 4 is below a predetermined threshold value can the extension 39, in particular the foldable section 39a, be moved via the weight valve 38, and the intermediate element 20 can thus also be moved counterclockwise to unlock the lid 5.

According to the embodiments of FIG. 5, FIG. 6, and FIG. 7, the actuating means 10 in the form of an actuator shaft 10b is configured and arranged to be manually actuated by a user, in that a section of the actuator shaft 10b arranged above the intermediate element 20 can be rotated manually or with a tool by a user to actuate the intermediate element—depending on the direction of rotation—and thus lock or unlock the lid 5 and/or actuating the valve 13. The valve actuating means 14 of FIG. 5, FIG. 6, and FIG. 7 is also configured and arranged to be manually actuated by a user in that a user lifts the valve actuating means 14, for example, at the mating contact slope 24 to thereby actuate the valve 13 and allow pressure to escape from the preparation space 4.

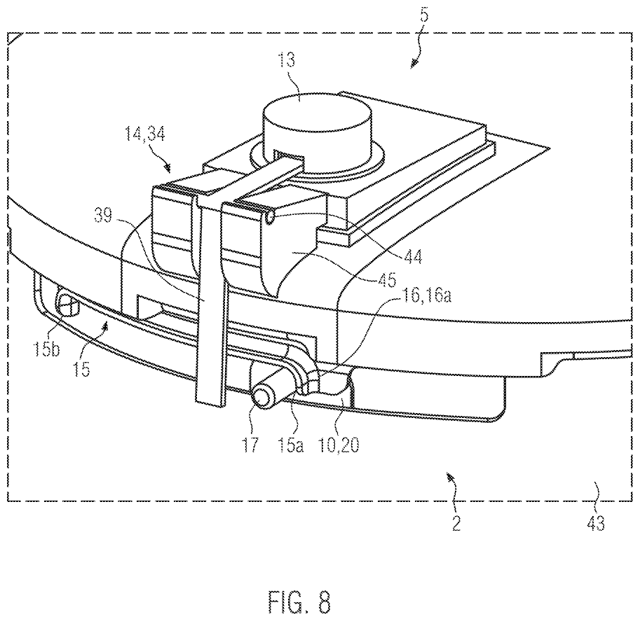

FIG. 8 shows an enlarged view of an embodiment of a preparation vessel 2 with a lid 5. A safety device 34 is in particular provided in the exemplary embodiment according to FIG. 8 in order to ensure that the lid 5 can only be unlocked when the pressure inside the preparation space 4 is below an uncritical threshold, for example of 4 kPa. The safety device 34 is part of the valve actuating mechanism 14 in this exemplary embodiment.

The safety device 34 has a pivotable extension 39. The foldable extension 39 is pivotably mounted about an axis 44 in a bearing block 45. The bearing block 45 is arranged next to the valve 13. The intermediate element 20, or at least an actuating means 10, has a projection 17 that is interactively arranged with the locking means 16, here a locking ring 16a. The projection 17 can be moved—similarly as described in FIG. 4—within a guide groove 15 between a first stop edge 15a and a second stop edge 15b so that the locking ring 16a is also moved depending on the direction of movement of the projection 17.

If the intermediate element 20 or the actuating means 10 is moved to lock the lid 5, the extension 39 is pivoted, for example, in such a way that it does not interact with the projection 17. A movement of the projection 17 in opposite direction—for unlocking—is blocked by the extension 39 until the pressure in the preparation space 4 has dropped below a threshold value, or the valve 13 is always actuated by pivoting the extension 39 to pass the projection 17 so that pressure that is present can escape.

It is also provided that the valve 13 interacts with the extension 39 in such a way that the extension 39 blocks a movement of the projection 17 and thus an unlocking of the lid 5 as long as the pressure inside the preparation space 4 is above a threshold value. It is further provided that at least one ramp—not shown—is arranged on the control means 10 and/or on the intermediate element 20 which, for example, causes an evasive movement of the pivotable extension during locking.

The valve actuating means 14 is configured and arranged for manual actuation by a user by means of the pivotable extension 39. The extension 39 can be pivoted manually by a user, whereby a valve 13 is actuated, in order to allow pressure to escape from the inner preparation space 4.

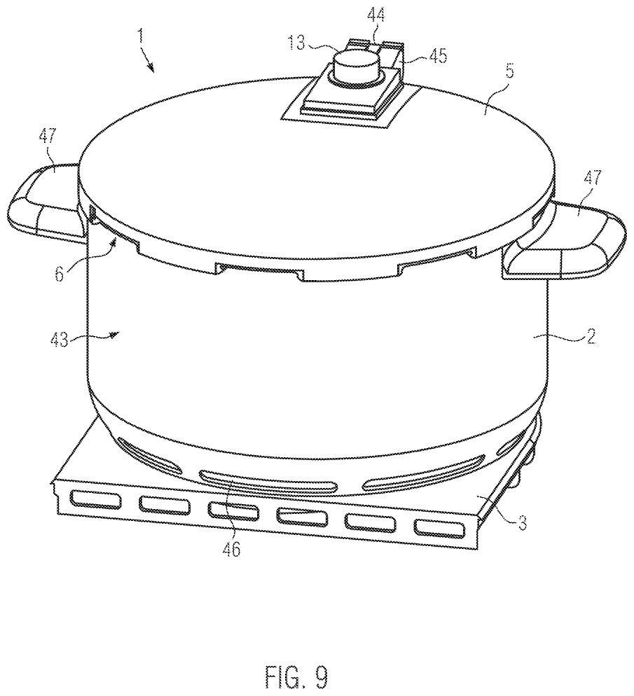

FIG. 9 shows an embodiment of a preparation vessel 2 with a lid 5, in which the actuator element 9, the actuating means 10, and other components, for example, the intermediate element 20, are arranged behind a lining 43. The preparation vessel 2 is arranged here by way of example on a part of a kitchen appliance base 3. In this exemplary embodiment, the lining 43 is arranged over the entire circumference and extends from the upper edge 6 of the preparation vessel 2 to the bottom area of the preparation vessel 2. The lining 43 preferably forms a double-walled construction and/or is insulated. The lining 43 has a plurality of openings in the bottom area of the preparation vessel 2, which are configured here as longitudinal grooves. The preparation vessel 2 has two carrying handles 47 arranged opposite one another over the circumference in the area of the upper edge 6.

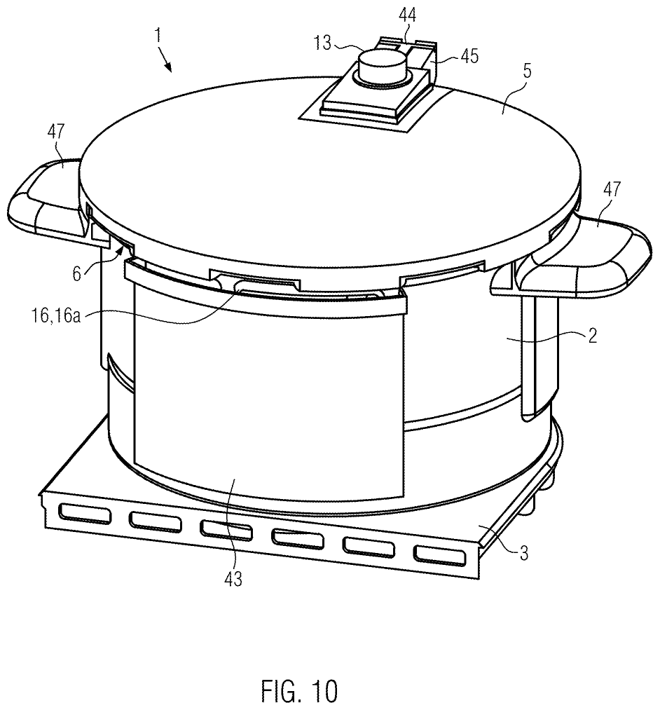

FIG. 10 shows of an embodiment of a preparation vessel 2 with a lid 5. The preparation vessel 2 has a lining 43 that extends over a part of the surface of the preparation vessel 2. The actuating means 10 and, for example, the intermediate element 20, are arranged behind the lining 43. In this exemplary embodiment, the lining 43 is partially arranged over the circumference and merely extends over a part of the height of the preparation vessel 2. The lining 43 forms a double-walled construction and/or is thermally insulated. The preparation vessel 2 has two carrying handles 47 arranged opposite one other over the circumference in the area of the upper edge 6.

In the present disclosure, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A preparation vessel arranged on a kitchen appliance base of a kitchen appliance having at least one preparation space, at least one lid for locking the preparation space, at least one actuator element, and at least one actuating means, wherein the actuator element is movably mounted in an interface area relative to the kitchen appliance base, the actuating means is actuated by the actuator element, and locking and unlocking of the lid is realized by actuating the actuating means,
wherein at least one valve and at least one valve actuating means are provided, and that the valve actuating means is actuated at least indirectly with the actuating means.

2. The preparation vessel according to claim 1, wherein the actuating means is at least partially rotatably mounted about a common first axis of rotation (X1) with the actuator element or the actuating means is at least partially rotatably mounted about a second axis of rotation (X2).

3. The preparation vessel according to claim 1, wherein a locking means is provided, the locking means is at least indirectly moveable by the actuating means for locking the lid, and the locking means is moveable by the actuating means at least between a release position and a locking position.

4. A preparation vessel according to claim 1, wherein a displaceable intermediate element is provided, the intermediate element is moveable by the actuating means, wherein a locking means is moveable at least between a release position and a locking position with the intermediate element, and/or the valve actuating means is actuated with the intermediate element.

5. The preparation vessel according to claim 4, wherein the intermediate element has at least one contact slope, and the valve actuating means is actuated with the contact slope.

6. A preparation vessel according to claim 4, wherein the intermediate element is movably mounted in a guide contour, and the guide contour is configured as a handle element on the outside of the preparation vessel.

7. The preparation vessel according to claim 4, wherein the intermediate element has at least one first tooth bar for interacting with the actuating means.

8. A preparation vessel according to claim 1, wherein the actuating means has at least a first tooth ring and at least a second tooth ring.

9. A preparation vessel according to claim 1, wherein the actuator element interacts in a form-fitting manner with the actuating means to move the actuating.

10. The preparation vessel according to claim 9, wherein the actuator tooth bar has at least a first tooth bar section and at least a second tooth bar section and the first tooth bar section and the second tooth bar section are spaced apart from one another by at least one intermediate area.

11. The preparation vessel according to claim 10, wherein a locking of the lid is realized via the actuating means with the first tooth bar section and an actuation of the valve actuating means is produced via the actuating means with the second tooth bar section.

12. A preparation vessel according to claim 1, wherein the actuator element has at least one locking contour, and the locking contour is configured for interacting with a mating locking contour on the kitchen appliance base.

13. A preparation vessel according to claim 1, wherein at least one safety device is provided, the safety device being arranged and configured to prevent the lid from being unlocked for as long as a threshold value of a pressure in the preparation space is exceeded.

14. A preparation vessel according to claim 1, wherein the valve actuating means and/or the actuating means are arranged and configured to be manually actuated by a user.

15. A kitchen appliance having at least one kitchen appliance base and at least one preparation vessel according to claim 1, wherein the preparation vessel is arranged in a receiving area on the kitchen appliance base;
wherein the kitchen appliance base has a drive means for interacting with the actuator element of the preparation vessel in the state of the preparation vessel in which it is arranged in the receiving area.

16. The preparation vessel according to claim 3, wherein the valve actuating means is configured to be actuated by the locking means.

17. The preparation vessel according to claim 5, wherein the contact slope is arranged at one end area of the intermediate element.

18. The preparation vessel according to claim 8, wherein the first tooth ring and the second tooth ring have different toothing properties to realize a translation.

19. The preparation vessel according to claim 9, wherein the actuator element has at least one actuator tooth bar.

20. The preparation vessel according to claim 10, wherein the first tooth bar section and the second tooth bar section are spaced apart from one another by at least one intermediate area, such that no force is transmitted from the actuator element to the actuating element in the intermediate area.
